(19) United States
(12) Patent Application Publication
(10) Pub. No.: US 2013/0191502 A1
(43) Pub. Date: Jul. 25, 2013

(54) SYSTEM AND METHOD FOR TRANSFORMATION AND DELIVERY OF SOFTWARE TO MOBILE PLATFORMS

(71) Applicant: Adroitent, Inc, Princeton, NJ (US)

(72) Inventors: Parthasarathy Bommireddy, Belle Mead, NJ (US); Srinath Devireddy, Belle Mead, NJ (US)

(73) Assignee: ADROITENT, INC., Princeton, NJ (US)

(21) Appl. No.: 13/731,620

(22) Filed: Dec. 31, 2012

Related U.S. Application Data
(60) Provisional application No. 61/581,467, filed on Dec. 29, 2011.

(51) Int. Cl. H04L 29/08

(52) U.S. Cl. CPC H04L 67/04
USPC 709/217

(57) ABSTRACT

A system and computer-implemented method for transforming and providing data objects to a mobile platform, wherein the data objects originate from a legacy software application and it are accessed by a mobile platform. The system and computer-implemented method further comprising user tools for accessing, selecting, activating and spatially manipulating widgets corresponding to the data objects for display on a mobile platform.

### RELATED APPLICATION DATA

This application claims priority to U.S. Provisional Application 61/581,467, filed Dec. 29, 2011, which is hereby incorporated by reference in its entirety

### BACKGROUND

There is an increased demand for mobile platform accessible software. That is, with the emergence of application oriented mobile platforms, e.g., phones, slates, tablets and similar devices having data connectivity, there is also an increased demand for software that is accessible via mobile platforms that provides a high-quality user experience and comprehensive functionality.

Application oriented mobile platforms include, but are not limited to, iOS, Android, Windows Phone, Blackberry or other similar mobile devices. In each of these cases, developers may deliver applications or “Apps” to a user via a marketplace or another download method. A user may access the marketplace and download applications that have been built or optimized for use with specific devices; for example, an application may be optimized as to a device's operating system, operating system flavor, device model, interface methodology (e.g. multi-touch, user gestures, keyboard, device hard buttons) or display resolution (e.g. aspect ratio or display size).

### BRIEF DESCRIPTION OF THE DRAWINGS

FIG. 1 is a block diagram of an exemplary system.

FIG. 2 is a functional flow block diagram of an exemplary system.

FIG. 3 is a block diagram of an exemplary system.

FIG. 4 is a functional flow block diagram of an exemplary system.

FIG. 5 is a functional flow block diagram of an exemplary system.

### DETAILED DESCRIPTION

There is a need in the art for a system and method capable of transforming legacy software from a legacy format to a mobile platform accessible format. In many IT environments, there are a great number of legacy software applications that are not natively accessible via mobile platforms. As is appreciated by those skilled in the art, this limitation may be due to a number of factors, including, but not limited to, prohibitively high cost of development, implementation or maintenance; an IT department's lack of financial resources to purchase mobile platform accessible version upgrades; software end-of-life (no further support provided by original developer); antiquated coding techniques that are not extensible to contemporary standards, data formats or communication networks; etc. Thus, it is desirable to be able to transform or extend existing legacy software applications to be accessible via mobile platforms in a manner that is dynamically optimized for use with specific mobile platforms.

For example, in the health care industry, there exist a wide range of legacy and non-legacy oftware applications that were developed and deployed prior to the pervasiveness of highly capable mobile platform devices, e.g., iOS, Android, Windows Phone, Blackberry devices in the form of e.g. phones, tablets, etc. These applications include human resource, vendor management, patient record management, payroll and resource routing/scheduling software applications. In each case, these applications may lack native capabilities enabling access to mobile platforms. Further, even in instances where the applications may be accessed via mobile browser applications, such instances do not leverage the native capabilities of the mobile platform or are not optimized for use with the mobile platform's interface. By way of further example, a patient record management software application (legacy or non-legacy) may only be accessible via a traditional MS Access database or other legacy database query format. It would, therefore, be desirable to enable the application to receive from and provide to a mobile platform relevant patient records based upon specific data requests provided by a user via a mobile platform. Furthermore, as discussed, it is desirable that the interface provided to the user match the characteristics of the device used and/or allow a user to spatially arrange the display of data provided from the legacy application according to a user's preferred display format.

Various embodiments of the present invention will be described in detail with reference to the drawings. Reference to various embodiments does not limit the scope of the invention, which is limited only by scope of claims attached hereto. Additionally, any examples set forth in this specification are not intended to be limiting and merely set forth some of the many possible embodiments. Also, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items.

The disclosed embodiments are a system and method for transforming and providing data objects to a mobile platform. As is appreciated by those skilled in the art, legacy software applications (and many non-legacy applications) are not typically accessible via mobile platforms. An intermediary format may, however, be provided to mediate communication between a mobile platform-based application and the legacy software application. The intermediary format may further be served in a format that is customized for display on the mobile platform and/or tailored to the user's preferences.

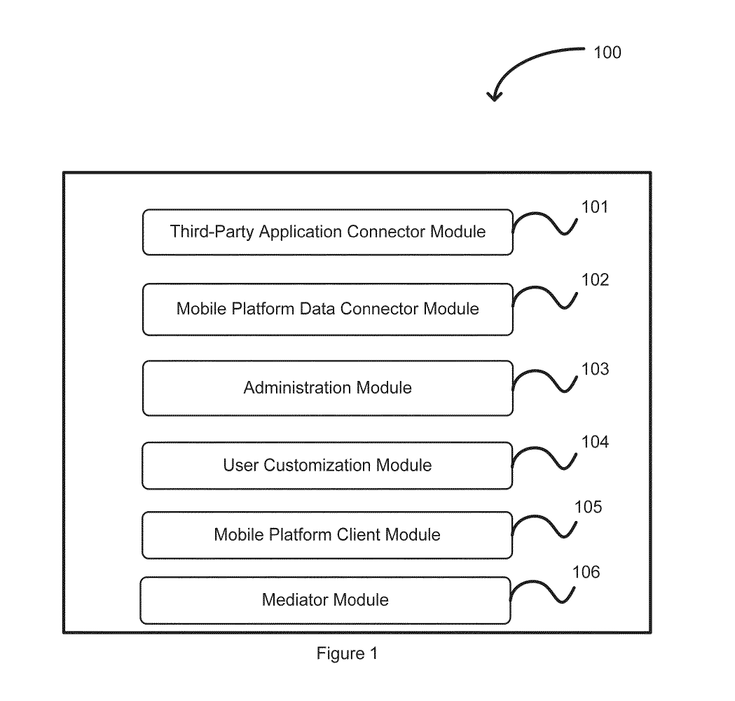

FIG. 1 depicts an overall view 100 of an embodiment. In an embodiment, the system 100 may comprise a plurality of modules, including Third-Party Application Connector Module 101, Mobile Platform Data Connector Module 102, Administration Module 103, User Customization Module 104, Mobile Platform Client Module 105 and Mediator Module 106.

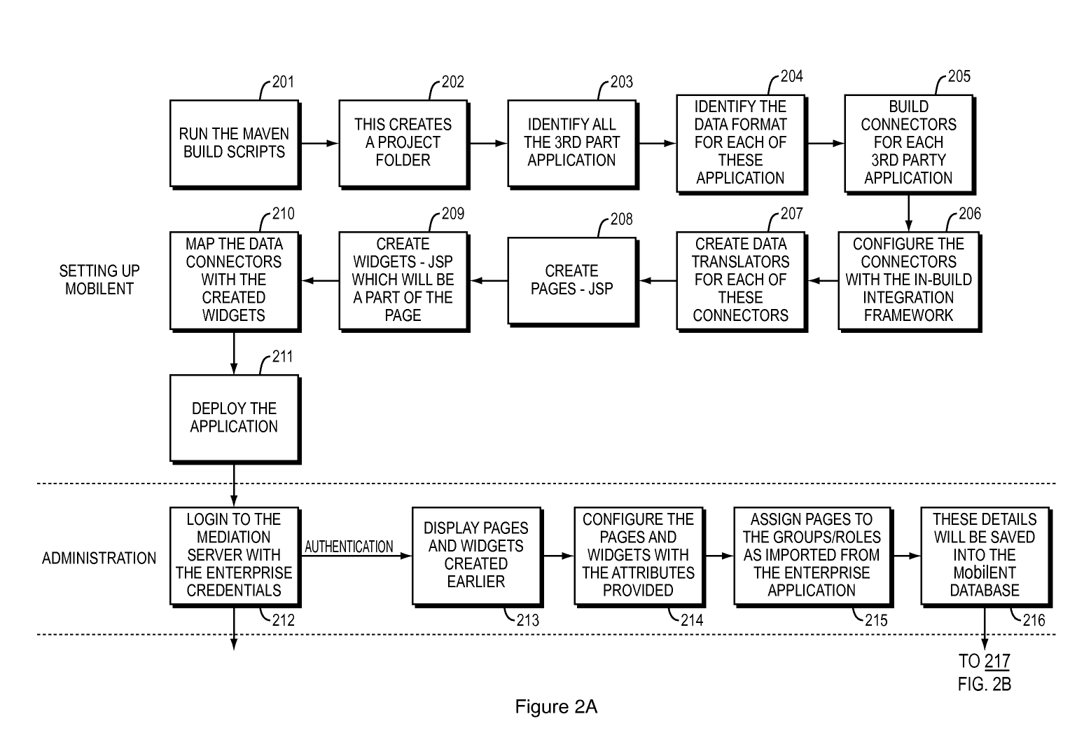

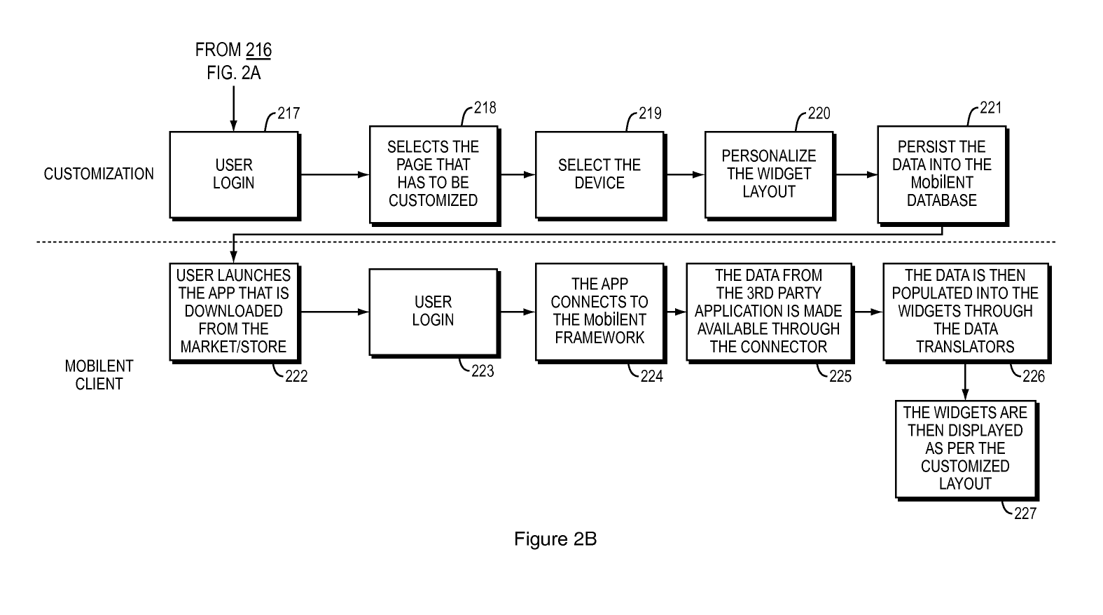

The Third-Party Application Connector Module 101, as discussed herein, may be executed via a build automation or software comprehension tool, e.g., Maven, and includes a range of functionality to prepare and define the intermediary format for the system 100. Referring in part to FIG. 2, the module 101 may include functionality or definitions to identify the third-party application 203 and identify the data format associated with each of the identified third-party applications 204. The identified applications may include any external systems and/or applications that the system 100 may require data communication with. Data communication may be executed via any means known in the art, e.g., via a web service. The system 100 may include data formats and software architecture for optimizing interactions between the system 100 and each external system and/or application, e.g., Web Server Definition Language (WSDL), Service Oriented Architecture (SOA), Representational State Transfer (REST), and others as are known in the art.

In addition, module 101 may include data connectors relating to the identified third-party applications, 205. That is, for each third party external system and/or application that has been identified and each associated data format, module 101 includes data connectors that enable the parsing of the respective data and data formats. Referring to block 206, each data connector 205 further includes configuration data sufficient to enable the data connector 205 to operate/communicate within the system/framework 100 and communicate data to each of the identified third-party application and or systems. Communication within the system 100, including communication to third-party applications/systems and mobile platforms, may be via any data communication means known in the art, including, but not limited to, TCP/IP over wired and wireless connections.

Referring to Mobile Platform Data Connector Module 102, the module may comprise translator 207 to transform data obtained from or communicated by module 101 to a mobile platform accessible format. The mobile platform accessible format may be a subset of the data obtained from the third party application or may further comprise additional data elements selected upon variable criteria conforming to the contextual uses of the third-party application via a mobile platform.

In addition, the mobile platform accessible format may include arrangement, display and context-specific attributes associated with either a target mobile platform selected from a plurality of different mobile platform profiles or the third-party application. By way of non-limiting example, a data set may be a “widget” wherein the widget is the subset selection of data available from the third-party application or system and the device, arrangement, display and/or context-specific attributes discussed herein. By way of further non-limiting example, data sets originating from the third-party application may be selected (i.e. made available for use) and display resolution for a target mobile platform may be set (e.g. min-width, max-width, min-height, max-height; in each case, applicable to either a widget or an acceptable range for a target mobile platform consistent with the native display resolution of a target mobile platform).

As is appreciated by those skilled in the art, in an embodiment, the translator may be configured to provide a plurality of widgets, 208, 209, 210. That is, whereas a first widget may provide the data set conforming to a first selection of data originating from the third-party application, a second widget may provide the data set conforming to a second selection of data originating from the third-party application.

In a further embodiment, the third-party application is a healthcare patient management system, wherein a first widget 302 includes profile information of a patient (including, but not limited to, patient name, age, address and contact information), a second widget 303 includes a profile photo or other identifying information of the patient, a third widget 304 includes a problems list (including, but not limited to, family medical health history, personal health history, diagnosed medical issues), a fourth widget 305 includes the patient's allergies and a fifth widget 306 includes the patient's medications. As is to be appreciated by one skilled in the art, the foregoing data selections are illustrative and may vary dependent upon the originating third-party application's data set. Additional widgets, 307, 308, 309, 310, comprising other or overlapping data elements may also be defined. The data sets comprising each widget are selections of available data provided from the legacy software application to the system 100. In each case, the individual widgets may include data sets from a plurality of third-party software.

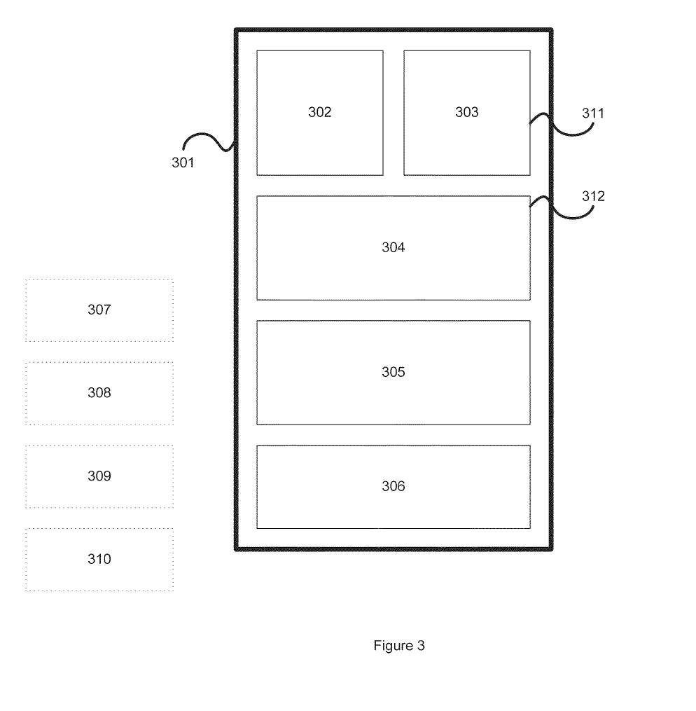

In a further embodiment, the third-party application may comprise web service APIs, wherein each web service API provides data utilized by one or more widget. Referring to FIG. 3, widget 302 may receive data from a first external application and widget 303 may receive data from a different API corresponding to the same first external application. By way of further example, widgets 303, 305 and 306 may receive data from any one of a plurality of external applications (including external applications other than the first external application). As is to be appreciated by one skilled in the art, the foregoing data selections are illustrative and may vary dependent upon the originating third-party application's data set. Additional widgets, 307, 308, 309, 310, comprising other or overlapping data elements may also be defined.

As discussed, each widget may serve as a container to hold data sets or subsets of data originating from the third-party application. Accordingly, the “size” or display resolution of each widget may vary dependent upon the volume of information contained in the container, 311, 312, or other administrator or user preferences. The display resolution may, however, be constrained by the display specifications of the target mobile platform or a particular mobile platform profile 301. As it may be desirable to stack widgets on a display, max/min resizing ranges may be defined by an administrator 103 or within the translator configuration itself.

Referring now to block 103, an administration module comprising at least an administrator interface is provided. The administrator interface may be provided via a browser-based service or a remote client application and include administrator authentication functionality, as is understood in the art. The module provides a user with access to widgets, e.g., 302, 303, 304, 305, 306, 307, 308, 309, 310, or, alternatively, the module provides an administrator with access to widgets for selection, arrangement and deployment to users or groups of users, 213, 214, 215, 216. In an embodiment, a spatial arrangement of the widgets conforming to an arrangement profile may be specified by an administrator. The module may further provide functionality for specifying pages for specific groups, sub-groups or collections of users, wherein a first group of users may require access to specific widgets and not require access to others.

In alternative embodiment, a collection of widgets may be activated or made available to users in the User Customization Module 104 as pages, wherein users may dictate the spatial arrangement and selection of widgets for display. In the case where the user interface to the administrator module is a graphical user interface, widgets may be selected, arranged or activated by dragging, dropping and resizing the widgets onto a palette corresponding to a mobile platform device display 301 or collection, as is to be appreciated by those skilled in the art.

Referring now to block 104, a User Customization Module is provided which may be accessed by an end-user via a web-browser, client application, a mobile platform application or any other means known in the art. The module may further comprise user authentication methodologies as is appreciated by those skilled in the art. In an embodiment, the user may access the collection or pages of widgets made available by an administrator 103. The user may specify the specific mobile platform via which the user intends to access the system 100, 219. As discussed herein, in an embodiment, the mobile platform selections may conform to defined mobile platform profiles or, alternatively, a user may define a new mobile platform profile by specifying the display resolution of the target device. The user may dictate the spatial arrangement and selection of widgets for display 220. In the case where the user interface to the User Customization Module is a graphical user interface, widgets may be selected, arranged or activated by dragging, dropping and resizing the widgets onto a palette corresponding to a mobile platform device display 301 or collection, as is to be appreciated by those skilled in the art. The user selections may be stored in a user profile in a system 100 accessible database 221.

Referring now to block 105, a Mobile Platform Client Module may be provided, wherein the module is embodied as a mobile application that may be downloaded onto the user's mobile platform (device). Alternatively, the Mobile Platform Client Module may be embodied as a mobile web-browser accessible web page. In either instance, the user may authenticate user credentials to gain access to the system 223. The Mobile Platform Client Module 105 may have a data connection to the system 100 via the wired or wireless data communication systems provided by the user's mobile platform.

The above-discussed mobile application shall provide user requests for data to the system 100. Referring now to block 106, the Mediator Module receives user requests from the mobile platform. The Mediator Module 106 is operatively coupled to the Third-Party Application Connector Module 101 and the Mobile Platform Data Connector Module 102. The Mediator Module 106 receives the user requests from the mobile application via a communications network and submits the request to the Third-Party Application Connector Module 101. The Third-Party Application Connector Module 101 translates the request, to the extent required to communicate with a third-party application, and requests the data from a third-party application via the connector corresponding to the third-party application. The third-party application is a third-party application capable of fulfilling the subject user data request.

The third-party application processes the request via its native functionality and returns a response (also via its native functionality). The response from the third-party application is received by the system via the Third-Party Connector Module 101 and communicated to the Mediator Module 106. The Mediator Module 106 communicates the received data response to the Mobile Platform Data Connector Module 102 for transformation of the provided response into a mobile platform accessible format.

Upon transformation of the data, the Mobile Platform Data Connector Module 102 populates the widgets with data corresponding to the data set comprised in the data response. The Mediator Module 106 accesses the populated widgets and serves the populated widgets to the Mobile Platform Client Module 105 via the communications network. The widgets are served in a manner complying with the user's selections, i.e., as stored in the user's profile including, but not limited to, the selection and spatial arrangement of widgets.

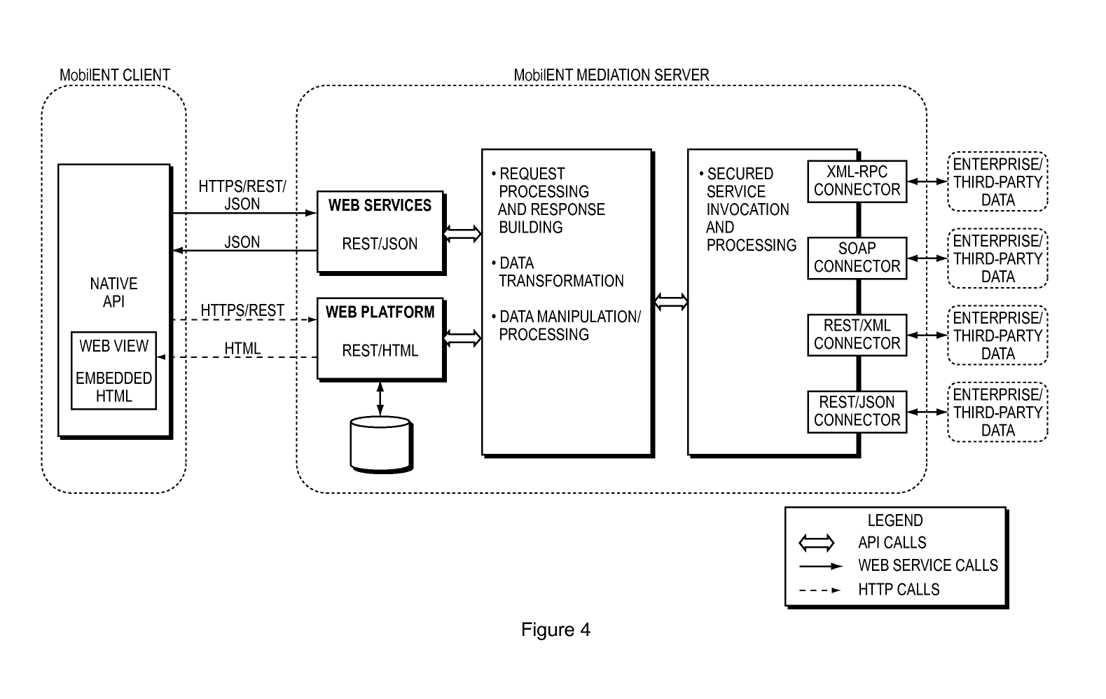

Referring to FIG. 4, a further embodiment of the invention is provided, wherein a mobile client provides user requests to a mediation server embodying the features of system 100. The disclosed mediation server receives the user's requests, processes the user's requests and invokes the relevant connector to access the third-party data. The third-party data is received in the third-party's native format and is transformed to a mobile platform accessible format via a connector provided by the mediation server. The mediation server serves the responsive data to the mobile client.

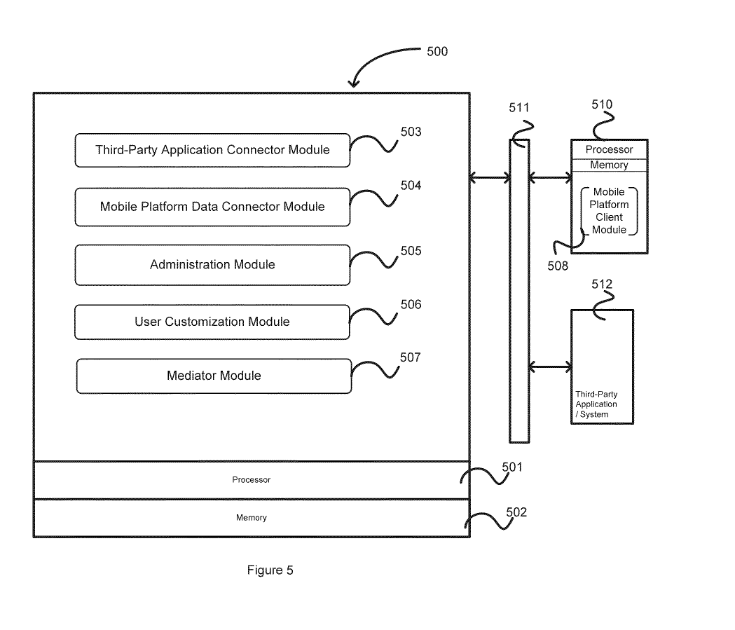

Referring to FIG. 5, a further embodiment 500 may include a computer having at least a processor 501 and 502, a Third-Party Application Connector Module 503, a Mobile Platform Data Connector Module 504, an Administration Module 505, a User Customization Module 506 and a Mediator Module 507. Each of the foregoing modules may perform in accordance with the embodiments of block 101, 102, 103, 104, 106, described herein, respectively. A mobile platform 510 may be provided which includes the Mobile Platform Client Module 508, wherein the mobile platform is a device having a processor, memory and a means for network data communication, as is appreciated by those skilled in the art. The mobile platform may further comprise a display, a user interface and a means of input, as is known in the art. In yet a further embodiment, the embodiment 500 may include a network 511, as is understood to those skilled in the art, for communication between devices or systems, 500, 510, 512. The various modules consist of computer software code recorded on computer readable media and executed by a processor. The modules are segregated by function in this description but need not be discrete devices or code portions. The modules can be segregated in any manner. Various computer devices can be used, such as Servers, PCs, tablets, handheld computing devices, mobile phones, or various combinations of such devices.

Application of the embodiments is not limited to the mobile platform context. Instead, it may be applied to any environment requiring the selection of user customization and access to a third-party system that would not be otherwise accessible to the user's specific device or platform in an optimized manner as discussed herein.

What is claimed is:

1. A computer system for transforming and providing data objects to a mobile platform, the system comprising:
a memory, storing computer executable instructions; and
a processor operatively coupled to said memory and configured to execute the instructions to perform the following steps:
identify an application having data objects for transformation to a mobile platform accessible format;
provide at least one connector for the application, wherein the connector includes at least one data object mapping from the application to the mobile platform accessible format;
receive over a communications network from a mobile platform having a display, a user request to access the application;
provide data responsive to the user request from the application, wherein the response is provided in the mobile platform accessible format corresponding to user interface selections provided in a user profile and compatible with the display of the mobile platform.

2. The system of claim 1, wherein the processor provides a gateway and interface for the user to create and modify the user profile, wherein the user profile comprises user selections.

3. The system of claim 2, wherein the user selections are user selected data objects in the application for display on the mobile platform.

4. The system of claim 2, wherein the user selections are selections of data objects in the application for display on a plurality of mobile platforms.

5. The system of claim 2, wherein the user selections are selections corresponding to the resolution of the display of the mobile platform.

6. They system of claim 2, wherein the user selections are selections corresponding to a spatial arrangement of user selected data objects in the application for display on the mobile platform.

7. The system of claim 3, wherein the user selections are selections corresponding to a subset of data provided in the user selected data objects.

8. A computer readable medium having stored thereon data representing sequences of instructions, which when executed by at least one computing device, cause the at least one computing device to:
identify an application having data objects for transformation to a mobile platform accessible format;
provide at least one connector for the application, wherein the connector includes at least one data object mapping from the application to the mobile platform accessible format;
receive over a communications network from a mobile platform having a display, a user request to access the application; and
provide data responsive to the user request from the application, wherein the response is provided in the mobile platform accessible format corresponding to user interface selections provided in a user profile and compatible with the display of the mobile platform.

9. A computer-implemented method for transforming and providing data objects to a mobile platform, comprising the steps of:
identifying, by a computer, an application having data objects for transformation to a mobile platform accessible format;
providing, by a computer, at least one connector for the application, wherein the connector includes at least one data object mapping from the application to the mobile platform accessible format;
receiving, by a computer, over a communications network from a mobile platform having a display, a user request to access the application; and
providing, by a computer, data responsive to the user request from the application, wherein the response is provided in the mobile platform accessible format corresponding to user interface selections provided in a user profile and compatible with the display of the mobile platform.
